(19) United States
(12) Patent Application Publication
(10) Pub. No.: US 2010/0020970 A1
(43) Pub. Date: Jan. 28, 2010

(54) System And Method For Camera Imaging Data Channel

(76) Inventors: Xu Liu, College Park, MD (US); David Doermann, Ellicott City, MD (US); Huiping Li, Clarksville, MD (US)

Correspondence Address: 24IP LAW GROUP USA, PLLC, 12 E. LAKE DRIVE, ANNAPOLIS, MD, 21403, US

(21) Appl. No.: 11/939,543

(22) Filed: Nov. 13, 2007

Related U.S. Application Data
(60) Provisional application No. 60/865,602, filed on Nov. 13, 2006.

(51) Int. Cl. G06K 7/10; H03M 13/07; H04L 9/00; G06F 11/10; G09C 5/00

(52) U.S. Cl. 380/255; 235/462.11; 714/784; 380/54; 714/E11.032

(57) ABSTRACT

A system and method for using cameras to download data to cell phones or other devices as an alternative to CDMA/GPRS, BlueTooth, Infrared or cable connections. The data is encoded as a sequence of images such as 2D bar codes, which can be displayed in any flat panel display, acquired by a camera, and decoded by software embedded in the device. The decoded data is written to a file. The system and method meet the following challenges: (1) To encode arbitrary data as a sequence of images. (2) To process captured images under various lighting variations and perspective distortions while maintaining real time performance. (3) To decode the processed images robustly even when partial data is lost.

### CROSS-REFERENCE TO RELATED APPLICATIONS

The present invention claims the benefit of the filing date of U.S. Provisional Patent Application Ser. No. 60/865,602 filed on Nov. 13, 2006 by Xu Liu, David Doermann and Huiping Li. This prior application is hereby incorporated by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates to a system and method for using cameras, such as in a cell phone, to download data.

2. Brief Description of the Related Art

Previously, work has been performed on mobile vision and recognition, mobile interaction and error correction coding.

The combined image acquiring, processing, storage and communication capability in mobile phones rekindles researchers' interests in applying traditional pattern recognition and computer vision algorithms on camera phones in the pursuit of new mobile applications. Camera phones have been used to recognize faces (Y. Ijiri, M. Sakuragi, and S. Lao, “Security management for mobile devices by face recognition,” in MDM '06: Proceedings of the 7th International Conference on Mobile Data Management (MDM'06) Washington, D.C., USA: IEEE Computer Society, 2006, p. 49), road signs (X. Chen, J. Yang, J. Zhang, and A. Waibel, “Automatic detection of signs with affine transformation,” in WACV '02: Proceedings of the Sixth IEEE Workshop on Applications of Computer Vision, Washington, D.C., USA: IEEE Computer Society, 2002, p. 32 and “A pdabased sign translator,” in ICMI '02: Proceedings of the 4th IEEE International Conference on Multimodal Interfaces, Washington, D.C., USA: IEEE Computer Society, 2002, p. 217), text (K. S. Bae, K. K. Kim, Y. G. Chung, and W. P. Yu, “Character recognition system for cellular phone with camera,” in COMPSAC '05: Proceedings of the 29th Annual International Computer Software and Applications Conference (COMPSAC'05) Volume 1, Washington, D.C., USA: IEEE Computer Society, 2005, pp. 539-544 and M. Koga, R. Mine, T. Kameyama, T. Takahashi, M. Yamazaki, and T. Yamaguchi, “Camera based kanji OCT for mobile phones: Practical issues,” in ICDAR '05: Proceedings of the Eighth International Conference on Document Analysis and Recognition, Washington, D.C., USA: IEEE Computer Society, 2005, pp. 635-639), and barcodes (E. Ohbuchi, H. Hanaizumi, and L. Hock, “Barcode readers using the camera device in mobile phones,” in Cyberworlds, 2004 International Conference on, 2004, pp. 260-265; A. Otero, “A robust software barcode reader using the Hough transform,” in ICIIS '99: Proceedings of the 1999 International Conference on Information Intelligence and Systems, Washington, D.C., USA: IEEE Computer Society, 1999, p. 313; S. Ando and H. Hontani, “Automatic visual searching and reading of barcodes in 3d scene,” in Vehicle Electronics Conference, 2001, pp. 49-54; H. Hee Il and J. Joung Koo, “Implementation of algorithm to decode two-dimensional bar code pdf-417,” 6^{th} International Conference on Signal Processing, Vol. 2, 2002, pp. 1791-1794; and E. Ouaviani, A. Pavan, M. Bottazzi, E. Brunelli, F. Caselli, and M. Guerrerro, “A common image processing framework for 2d barcode reading,” 7^{th} International conference on Image Processing and its Applications, vol. 2, 1999, pp. 652-655.). Although the methods differ for individual application, some follow common procedures, summarized as follows:

1) Target Location: The first step is to locate the target's position. On traditional desktop/workstation environments, sophisticated methods can be applied. For mobile devices, however, detection often needs to run in real time and consume less resource to save power (which means the longer battery life). Lightweight or approximate features are explored to achieve these goals. For example, Viola and Jones used efficient rectangular features in “Robust real-time face detection,” Int. J. Comput. Vision, vol. 57, no. 2, pp. 137-154 (2004), for face detection on a Compaq PDA. Road sign or text detection often uses heuristic methods. For 2D barcode acquisition an unique pattern is often used to identify by its location. For example, a Maxicode contains a bull eye pattern at its center, a QR Code uses three squares at its three corners as locator patterns, and Datamatrix has its two perpendicular edges. Algorithms are designed to locate these locator patterns efficiently.

2) Image Enhancement and Distortion Correction: Camera phones often use cheap CMOS sensors with fixed focus. Compared with digital cameras with high quality CCD sensors, images captured by camera phones are relatively low quality. One problem is uneven lighting. Images captured by camera phones often have cast or attached shadows. Adaptive binarization is often used to reduce the effect of shading and uneven lighting. Another problem is perspective distortion. When users capture images, it is impractical for them to hold devices at a perfectly right angle. As a result, perspective distortion is inevitable and geometrical correction is required to normalize the image before recognition. Focus is another problem to be tackled. Cameras in mobile phones are designed to take pictures of people and scenes. For this reason the focal length of camera is often set to a distance >1 foot. To keep a reasonable resolution, however, physical barcodes need to be put close enough to cameras, leading to blur in the acquired image. A super resolution method was proposed to solve this problem in S. Baker and T. Kanade, “Limits on superresolution and how to break them,” IEEE Trans. Pattern Anal. Mach. Intell., vol. 24, no. 9, pp. 1167-1183, 2002, but the complexity of the algorithm prevents it from being run on mobile devices. To handle these problems the symbology should be robust enough to compensate for the adverse effects caused by image degradation.

3) Recognition: For recognition, features with geometric invariance are often selected since images are usually captured by cameras at arbitrary angles. Geometric invariants are used explicitly or implicitly in previous work. See I. Weiss, “Geometric invariants and object recognition,” Int. J. Comput. Vision, vol. 10, no. 3, pp. 207-231, 1993 and F. Mindru, T. Tuytelaars, L. V. Gool, and T. Moons, “Moment invariants for recognition under changing viewpoint and illumination,” Comput. Vis. Image Underst., vol. 94, no. 13, pp. 3-27, 2004. Explicit features include moments or the Fourier descriptors. See S. K. W. Kwok and J. C. H. Poon, “Viewpoint-invariant Fourier descriptors for 3 dimensional planar shape representation,” Electronics Letters, vol. 32, no. 19, pp. 1775-1776, 1996, 00135194. An example of implicit features is to locate feature points based on reference points, which is commonly used for decoding 2D barcodes. For example, when the three rectangular location patterns of a QR code are located, the positions of other unit cells in the QR code can be decided and the encoded information will be decoded.

One challenge for camera phone related applications is the user interface. Due to the physical limitation of mobile phones (small keypads, small displays, etc.), the designing of interface to facilitate users' interaction with the device is an important problem. Interaction with mobile devices received much attention in recent years as the popularity of camera phones and PDAs has increased. A survey of camera phone related applications can be found in T. Kindberg, M. Spasojevic, R. Fleck, and A. Sellen, “The ubiquitous camera: An in-depth study of camera phone use,” IEEE Pervasive Computing, vol. 4, no. 2, pp. 42-50, 2005. Some interesting applications include: Researchers at CMU use camera phone based 2D barcode solution for human identity authentication. J. M. McCune, A. Perrig, and M. K. Reiter, “Seeing is believing: Using camera phones for human verifiable authentication,” in SP '05: Proceedings of the 2005 IEEE Symposium on Security and Privacy. Washington, D.C., USA: IEEE Computer Society, 2005, pp. 110-124 In R. Ballagas, J. Borchers, M. Rohs, and J. G. Sheridan, “The smart phone: A ubiquitous input device,” IEEE Pervasive Computing, vol. 5, no. 1, p. 70, 2006, a camera phone is used as a pervasive input device to acquire position and motion information. The authors described a new scheme in P. Vartiainen, S. Chande, and K. Ramo, “Mobile visual interaction: enhancing local communication and collaboration with visual interactions,” in MUM '06: Proceedings of the 5th international conference on Mobile and ubiquitous multimedia. New York, N.Y., USA: ACM Press, 2006, p. 4, allowing users to use their camera phones to interact with large screen displays. The work described in A. Wilhelm, Y. Takhteyev, R. Sarvas, N. V. House, and M. Davis, “Photo annotation on a camera phone,” in CHI '04: CHI '04 extended abstracts on Human factors in computing systems. New York, N.Y., USA: ACM Press, 2004, pp. 1403-1406 allows users to annotate digital photos when capturing. In summary the unique challenges which need to be considered when developing applications related to the user interaction with camera phones include:

1) Image Distortion: When users capture images, one cannot expect them keep the image plane of a camera phone parallel with the physical plane. Perspective distortion is expected.

2) Small input keypads and displays: The user interface should be intuitive enough.

Images captured by camera phones are often of low quality due to perspective distortion, noise and shading. Decoding errors are inevitable, and extra bits need to be inserted to correct them. More specifically, data needs to be encoded with error control codes. Error control coding (also known as error correction coding) is an important technology developed in information theory. In general, error correction codes can be divided into convolutional codes and block codes. For a convolutional code, the entire code word is convolved. A deconvolution process is required to restore the data for decoding. For a block code, error correction bits are appended to the original code word, i.e. the code word is intact but appended by error correction bits. Previously, convolutional codes were widely used. Today researchers realize the combination of both convolution and block codes provides the best result which approaches the Shannon limit, the maximal capacity of a noisy channel. The Low Density Parity Check (LDPC) Codes (T. J. Richardson and R. L. Urbanke, “Efficient encoding of low density parity-check codes,” Information Theory, IEEE Transactions, vol. 47, no. 2, pp. 638-656, 2001, 00189448) and the Turbo Codes (B. Vucetic and J. Yuan, Turbo codes: principles and applications, Norwell, Mass., USA: Kluwer Academic Publishers, 2000) are designed based on this idea and widely used in applications such as deep space exploration (C. Jr, C. Stelzreid, L. Deutsch, and L. Swanson, “Nasa's deep space telecommunications road map,” 1999). However, decoding of convolved block codes requires computational power beyond current mobile devices. Especially, the floating point Viterbi decoding inhibits real-time performance on today's camera phones. Therefore, convolutional codes are not used.

A variety of systems and methods for downloading data to mobile devices such as cell phones, PDA's, MP3 players, and portable gaming systems are known. Such systems and methods include CDMA/GPRS, BlueTooth, infrared and cable. While such systems and methods have proven useful, they fail to take advantage of the fact that cameras are increasingly being incorporated into such devices.

### SUMMARY OF THE INVENTION

The present invention is a novel system and method which allows a camera to be repurposed to download data from an image or a series of images. This camera-based system has several unique advantages. First, it uses existing hardware infrastructure and local communication, so there is no extra data cost. Some of the existing data downloading methods, such as wireless communication data networks (GPRS/CDMA), will trigger charges by service providers. Second, the present invention can be implemented predominantly through software. Users do not need to connect their phones with PCs through cables or BlueTooth adaptors and there will be no complex driver installation or synchronization problems. Users need to simply aim the camera at the visual code, or “V-Code”.

In one embodiment, the present invention is a method for transferring data to a mobile device having a processor, a storage means, and a camera. The method comprises the steps of encoding data in a visual code where the visual code comprises a plurality of two-dimensional bar codes, displaying the visual code, capturing the plurality of two-dimensional bar codes with the camera and decoding the plurality of two-dimensional bar codes. In other embodiments, visual codes other than two dimensional bar codes may be used. The step of displaying comprises displaying a portion of the plurality of two-dimensional bar codes sequentially. In one embodiment, the encoding step comprises spatial (intra frame) and temporal (inter frame) encoding with Reed-Solomon error correction codes. The Intra-frame error correction corrects errors within each frame and Inter-frame error is used to recover the dropped frames. The encoding step comprises encryption by user-designed masks. Users can design their own mask and fuse the mask information into the data frame by bitwise AND or OR operation. The receivers can decode the data only when they have the key associated with the designed mask. The plurality of two-dimensional bar codes may square, rectangular, circular, or any other shape. Further, the plurality of bar codes may be different in shape. The decoding step comprises boundary tracking with fast Hough transform to locate the code frame in real time. In another embodiment, the method further comprises the step of displaying a detected boundary in real time to assist a user in aiming the camera at the V-Code frame.

The decoding step may comprise fast perspective correction. Instead of solving a plane-to-plane projection which requires large amount of floating points operation. We use intermediate affine coordinate transform which simplifies homogeneous estimation to inverting two signs of a homography. In this way we eliminate floating operations and the speed of perspective correction is significantly improved. Further, colors may be embedded in the two-dimensional bar codes.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a diagram of a frame of a 2-D bar code in accordance with a preferred embodiment of the present invention.

FIG. 2 is a block diagram of the architecture of a preferred embodiment of the present invention.

FIG. 3 is a diagram illustrating a data partition of a data file in accordance with a preferred embodiment of the present invention.

FIG. 4 is a diagram of a sequence of frames of 2-D bar code in accordance with a preferred embodiment of the present invention.

FIG. 5 is a diagram of a mask with a checker board pattern in accordance with a preferred embodiment of the present invention.

FIG. 6 is a diagram of a system in accordance with a preferred embodiment of the present invention.

FIG. 7 is a diagram of frame rendering and a mask in accordance with a preferred embodiment of the present invention.

FIG. 8 is a photo of a frame captured by a camera phone in connection with a preferred embodiment of the present invention.

FIG. 9 is a diagram of a geometrical transformation between matrix and perspective image in accordance with a preferred embodiment of the present invention.

FIG. 10 is a flow chart of a decoding process in accordance with a preferred embodiment of the present invention.

FIG. 11 is a diagram of four manually polluted codes which are still decodable by a preferred embodiment of the present invention.

FIG. 12 is a series of graphs illustrating the number of erroneous bits over 100 frames for four settings ((a) 28×35; (b) 32×40; (c) 40×50; and (d) 48×60) in an Example of the present invention.

FIG. 13 is a graph illustrating the relationship between E and EBR in an example of the present invention.

### DETAILED DESCRIPTION OF THE PREFERRED EMBODIMENTS

Embedding information in images (see Kutter, M., And Petitcolas, F. A., “Fair evaluation methods for image watermarking systems,” Journal of Electronic Imaging 9 (October 2000), 445-455) and videos (see Dittmann, J., Stabenau, M., and Steinmetz, R., “Robust mpeg video watermarking technologies,” MULTIMEDIA '98: Proceedings of the sixth ACM international conference on Multimedia, ACM Press, New York, N.Y., USA, 71-80 (1998)) has been studied for digital watermarking. The purpose of watermarking typically is for authorization and protection of the media. In the preferred embodiments of the present invention, data is encoded to facilitate the communication between the mobile device and the computer.

Known 2D barcode systems such as CyberCode (see Rekimoto, J., And Ayatsuka, Y., “Cybercode: designing augmented reality environments with visual tags,” DARE '00: Proceedings of DARE 2000 on Designing augmented reality environments, ACM Press, New York, N.Y., USA, 1-10 (2000)) and QR code (Ohbuchi, E., Hanaizumi, H., And Hock, L. A., “Barcode readers using the camera device in mobile phones,” CW '04: Proceedings of the 2004 International Conference on Cyberworlds (CW'04), IEEE Computer Society, Washington, D.C., USA, 260-265 (2004)) can encode very limited amounts of data. For example, the QR code can encode at most 2 KB data. To compensate for this limitation, the present invention encodes a file or files of any size into a series of frames where each frame encodes a part of the file or files. These frames are captured by the camera, decoded, and stored on the device in which the camera is located. The frames may be merged into one or more files.

The approach of the present invention will enable new applications and benefit numerous industries. The following examples will provide one of skill in the art with an idea of the potential scope of these new applications and benefits:
1. File Transfer where users would like to either send or receive electronic files. For instance, files can be downloaded and stored on the device, or other data such as appointments and contacts can be easily transmitted to device.
2. Online content can be encoded as a “V-Code”, which can be downloaded by the user to read offline on his/her mobile phone. It should be pointed out that the content provider does not need to explicitly generate the “V-Code”. In this instance, the providers need only link the electronic file with a URL address where the web service will generate the “V-Code”.
2. Advertisers can display the “V-Code” at a corner of the TV screen, computer screen, kiosk, or other display. This may encode supplemental information such as URL, telephone number, and/or special offers. Similar scenarios can be devised for any business or entity that wants to passively transmit more information about themselves. Graphics can be integrated to enhance branding.
3. Companies can use “V-Code” to release their software such as games, ring tones, or theme pictures. For instance, electronic game company wants the user to develop gaming character that they can save to their phone and then download to a friend's game console and play.
4. Security: The “V-Code can be encrypted before transmitting or posting the file even when using non-secure methods. For instance, someone leaves an encrypted “V-Code” message on their public webpage for only one or a few people with the password to view. Or, a business needs to transmit a message to an employee in the field when the business thinks someone has compromised their security wall.
5. Passive interaction: When an entity wants to give information and they want users to get the information whenever the users want. For instance, vendor at a conference wants visitors to be able to have all of the company literature and handouts downloaded to visitors while they wander the booth, but not actively transmit.

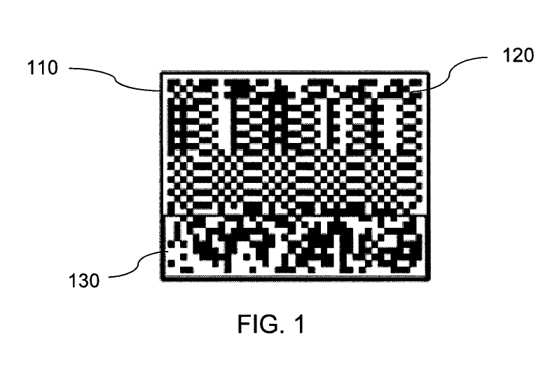

Instead of using existing 2D barcode symbologies such as QR code or Data Matrix, a preferred embodiment of the present invention uses its own symbology, for example, as shown in FIG. 1. The motivation of designing a new symbology was that the video/image captured by camera phones usually has an aspect ratio of 4:3 (width:height) and are not square like barcodes. The physical shape of new symbology shown in FIG. 1 is a rectangle with the aspect ratio of 4:3. In this way more data can be encoded in a single frame. The code area consists of two parts. A rectangle bounding box 110 defining the boundary of the code and a data area. The boundary can be used as the detection pattern and can be easily detected using fast Hough transform (see Duda, R. O., and Hart, P. E., “Use of the Hough transformation to detect lines and curves in pictures,” Commun. ACM 15, 1, 11-15 (1972)). The data area consists of black and white cells 120 inside the rectangle box 110 with bottom 130 used for error correction. Each cell in the data area represents one bit of the data with black color representing 1 and white color representing 0. While a preferred embodiment of the present invention incorporates this new symbology, other symbologies may be used with the present invention.

While the symbology shown in FIG. 1 is a rectangle, other forms are possible. For example, the symbology could be in the form of an animated character.

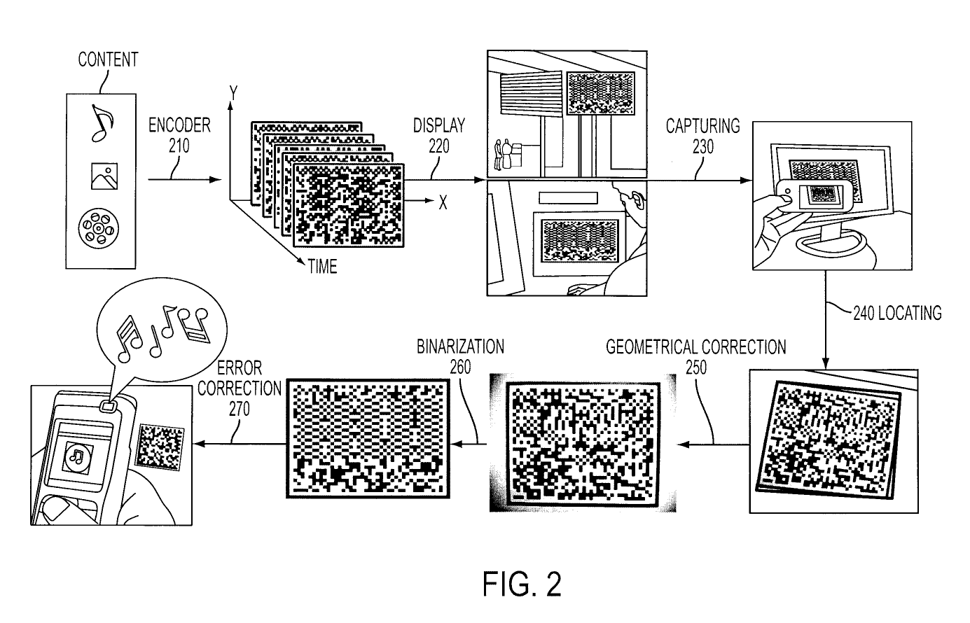

An overview of the architecture of an embodiment of the present invention is shown in FIG. 2. The system can be loosely partitioned into encoding 210, frame display 220, barcode acquisition 230, code area detection 240 and recognition 250, 260, error correction 270 and their implementation on mobile devices.

Overall, the procedures include:
A design of an exemplary symbology by considering the specifics of various devices.
The development of an encoder so that any data stream can be encoded using the exemplary symbology.
The development of display components so that a symbology can be displayed on flat panel displays.
The development of components for acquisition and processing of images, including a user interface, acquisition and image enhancement components. These will include detection, normalization, perspective correction to facilitate recognition and decoding.
Decoding the captured code frame by frame and reconstruct the data encoded.
Integrating all of the algorithms onto the mobile device. We designed a preliminary user interface, developed integrated software on mobile devices, and optimized code for best resource utilization.
Performing an extensive evaluation. We defined metrics and procedures for detection and recognition, and evaluate the robustness of the modules under different imaging conditions.

A preferred embodiment of the method of the present invention starts with encoding.

### A. VCode Encoding

To encode a data file into a VCode, we first split the data file into small segments, and then encode each segment into an image sequence. While the scheme is straightforward, the challenge is to make the encoding robust to the degradation and data loss which are inevitable in the imaging process. The cameras on phones often have much lower quality than digital cameras, and we expect users to capture VCode in real environment without constraints in lighting and perspective angles. Our strategy is to use state of the art error control in both time and space to make code more robust against these types of degradations.

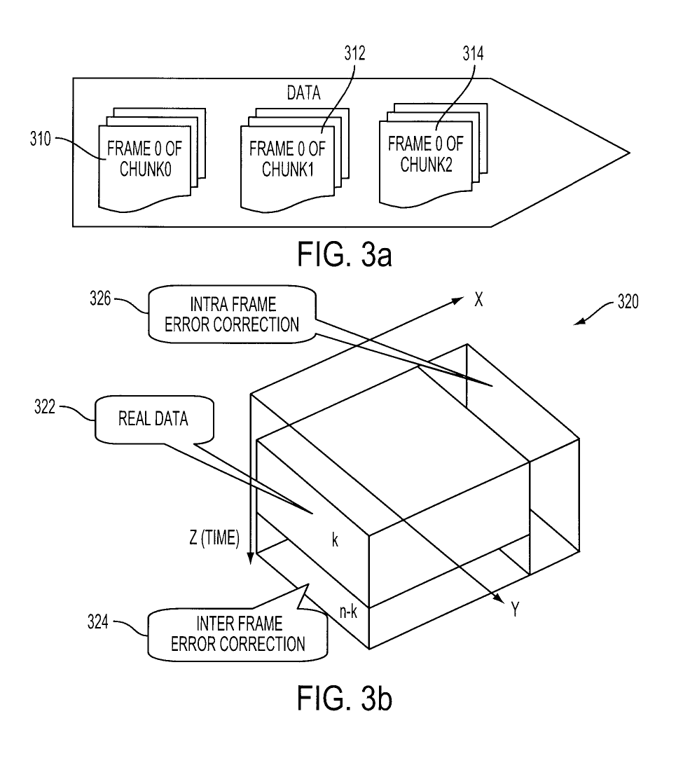

1) Data Partitioning and Error Correction: The data is partitioned in the way that both intra and inter error correction bits can easily be inserted. We divide the data into multiple chunks, each of which is further divided into individual frames. This forms a three layer structure of the data representation, as shown in FIG. 3.

FIG. 3b shows the error correction scheme we propose in each chuck. Each data chunk 310, 312, 314 in FIG. 3a can be visualized as a “Cube” 320, which consists of three areas: the data area 322, inter frame error correction area 324 and intra frame error correction area 326. The data file to be encoded is filled into this “Data Cube”320 (FIG. 3b). In this way, a three-dimensional coordinate can be assigned to each bit. Specifically, the error correction encoding scheme of a preferred embodiment of the present invention is described as:
1) Partition data: Split the data into chunks, each of which has the dimension K×W×H, where K is the frame number, W and H are the width and height for each frame.
2) Correct inter frame errors: Scan each column along the Z (time) axis of the data cube and add error correction bytes for each column scanned. Since we have K data frames in the “Data Cube”. We add (N−K) frames at the end of each chuck as inter frame error correction frames. We then can use a (N, K)-Reed-Solomon code to encode each chunk into an K×W×H cube. These redundancy frames will be dropped if they are not needed.
3) Correct intra frame errors: We add error correction code by padding extra bits to each frame on the x-y plane. Each frame is extended from size W×H to W×(H+R).

Each frame consists of three parts: the frame header, the data area and the error correction area. The frame header contains the frame index, chunk index, the total number of chunks, and a checksum. The frame and chunk indexes provide the position of each frame so it can be put into the right position after decoding. The checksum is used to check if the decoded frame and chunk indexes are correct. If they are incorrect, the whole frame will be dropped and recovered later by error correction frames. The number of chunks is uniform on all frames and can be used to check if the file is downloaded completely. We put on every frame so users can begin capturing from any frame (the VCode will be displayed in a loop until all data frames are correctly captured and decoded).

A preferred embodiment of the present invention uses Reed-Solomon encoding for error correction (see Wicker, S. B., and Bhargava, V. K., Reed-Solomon Codes and Their Applications. John Wiley & Sons, Inc., New York, N.Y., USA (Eds. 1999)). Reed-Solomon error correction is used in a wide variety of commercial applications such as CDs and DVDS. Typically a (n, k) Reed-Solomon code block can encode k bits data with n−k bits for error correction. If the locations of error bits are unknown in advance, which is the present case, then a Reed-Solomon code can correct up to (n−k)/2 error bits. The advantage of Reed-Solomon error correction is no matter where the errors occur (on data area or on the error correction area, or even on both), they will be corrected as long as the number of error bits is not larger than (n−k)/2. FIG. 1 shows a (150,100) Reed-Solomon encoded data where 800 and 400 bits are used for data and error correction, respectively. While Reed-Solomon encoding is used for error correction in a preferred embodiment of the present invention, other error correction techniques may be used.

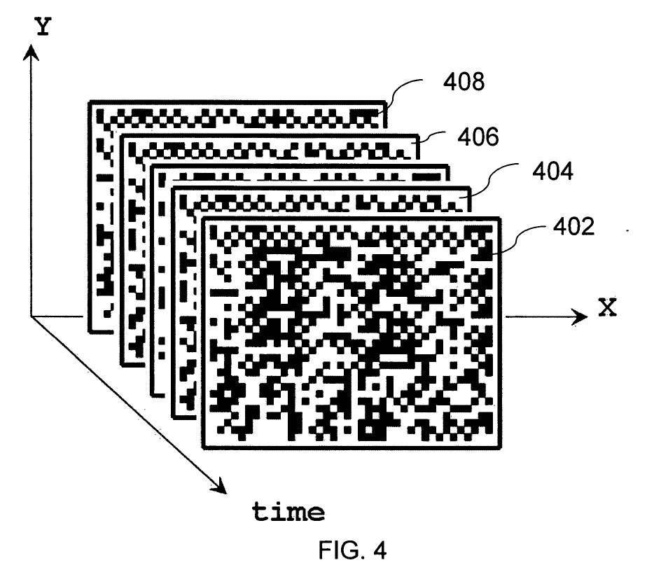

After defining the individual frame, a large data file can be split into many smaller chunks so that the data in each small chunk can be encoded into one frame. These images 402, 404, 406, 408 are piled up along the time axis to form a “V-Code”, as shown in FIG. 4. Theoretically the amount of data that a “V-Code” can carry is unlimited.

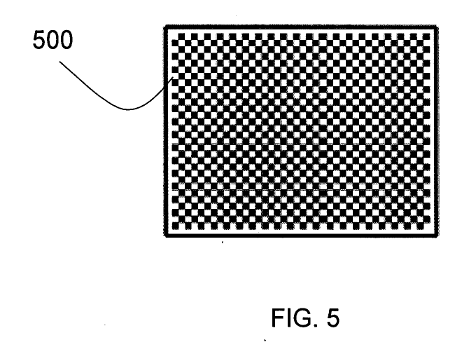

After encoding the data into a “V-Code”, the present invention xor's a mask with a checkerboard pattern, such as is shown in FIG. 5, to each frame. Using masks can provide security to the data since decoding is impossible without the mask used to xor the data. The checkerboard mask is used in a preferred embodiment of the invention because it can facilitate the binarization of captured images. One skilled in the art will understand, however, that other masks may be used with the present invention. The details will be discussed in the next section.

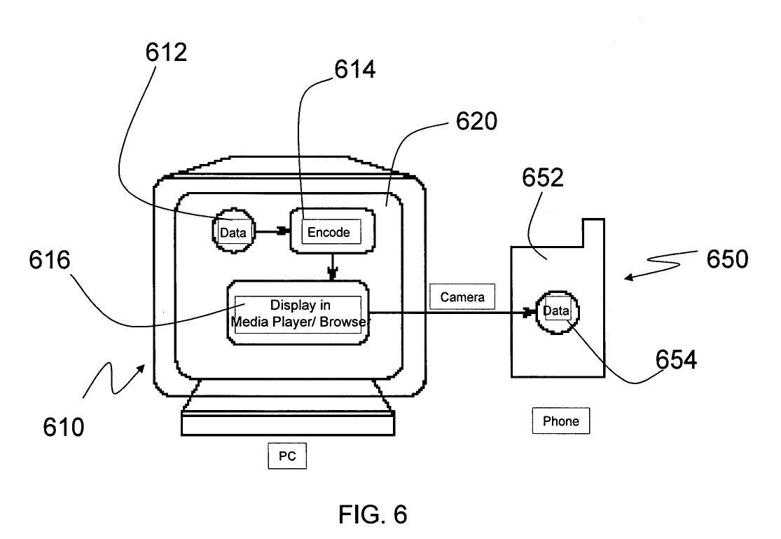

FIG. 6 shows the overview of a preferred embodiment of system in accordance with the present invention. On the PC side 610, the encoder 614 splits the data 612 into small chunks and encodes them into a “V-Code”, which can be displayed sequentially in media player or web browser 616 on any flat panel display 620. Each frame is displayed long enough (half a second, for example) so it can be captured before it disappears. On the camera phone side 650, users aim their cameras 652 at the “V-Code” and the software will capture the “V-Code” frame by frame, decode it, concatenate the decoded data 654 and save the final result.

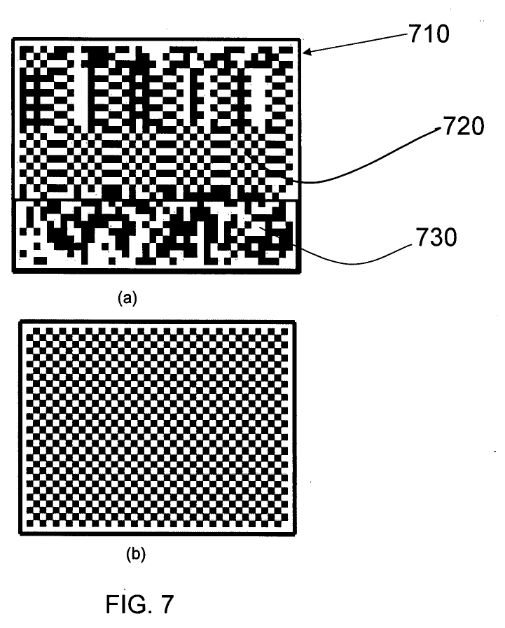

2) VCode Rendering: The rendering converts each frame (including error correction frames) into an image, which can be displayed on flat screens. Rather than using existing 2D barcode symbologies such as QR codes or Data Matrix (which are inherently static), we designed our own symbology, as shown in FIG. 7a, to maximize the data capacity. Since the sensors in camera phones are often not square, our design for the frame of a VCode is a rectangle to have a similar aspect ratio to the captured image. As shown in FIG. 7a, the code area consists of two parts: a rectangle bounding box 710 defining the boundary of the code, a data area 720 and an error correction area 730. The boundary can be used as the detection pattern and can be efficiently detected using a new fast Hough transform method. The data area consists of black and white cells, each carrying one bit of data with black representing 1 and white representing 0.

Before a frame is rendered, we use a mask to xor each frame. The mask provides encryption to the data since decoding is almost impossible without preknowledge of the mask. This allows the data to be downloaded only by users who have the “passcode”. A typical mask is shown in FIG. 7b.

### B. VCode Acquisition

The acquisition size and frame rate are constrained by the device. The process, however, must optimize throughput by trading off acquisition speed, image resolution, and processing requirements. Ideally we would choose the highest resolution which remains robust to degradation, yet can be processed at frame rates. Although camera phones often allow users to capture images with different resolutions, from 160×120 to 1600×1200 (2M pixels), our initial experiments suggest that QVGA resolution is a balance between speed and image quality for current mid level devices. The acquisition process itself is very simple: Users only need to aim the camera at the VCode to keep the frames at the center of the display. Detection and decoding will occur at frame rate.

### C. Decoding

Before decoding, each captured frame needs to be perspectively corrected, enhanced, and converted into a binary sequence.

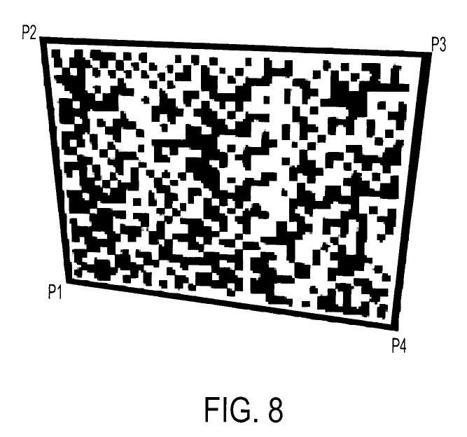

1) Image Processing: The algorithm must be very efficient to meet the real-time requirement. A typical preview frame is shown in FIG. 8. We have identified the following challenges when processing the detected image:
Perspective distortion: when users capture the image, it is not guaranteed that the camera image plane is parallel with the display plane. Perspective distortion is inevitable. The rectangle boundary box appears to be an arbitrary quadrangle (P1, P2, P3, P4) in the image.
Uneven lighting: Parts of the image are darker than other parts.

### Detection and Localization

Our localization pattern is a bold rectangular bounding box, as shown in FIG. 7. A common way to detect this pattern is to use the Hough transform, but it is computationally expensive. Since the barcode resides roughly at the center of the image, we can accelerate it by constraining the detection range. First, we scan each line of the image and find the left most and right most valley of each line. After finding these valleys we run the Hough transform to find the left and right boundaries. The top and bottom boundaries are detected in a similar way. This modified Hough transform is very fast and can be implemented in real-time since the boundary scanning and verification is very efficient (linear to the number of pixels on the boundaries). FIG. 8 shows an example of detection. When the four corners of the detected bounding box are visible, the program starts to enhance the image and decode. Otherwise, it moves to the next frame.

### Correction of Perspective Distortion

The biggest challenge is to decode the real images captured by camera phones. One example is shown in FIG. 8. To make the system robust, the system should handle uneven lighting and perspective distortion. At the same time the algorithms must be efficient enough to run in real time on resource constrained camera phones.

The problem of uneven lighting is typically not critical for monocolor images because black and white are quite distinct from each other. If the numbers of black and white cells are roughly equal in the image, the average pixel value of the image is a reasonable threshold to separate them. If one color dominates however, the global thresholding will not be a good solution since cameras often have automatic white balance. Instead of using complex adaptive binarization methods, a preferred embodiment of the present invention uses a mask (as shown in FIG. 5) to prevent any color from dominating. If a long chunk of the encoded data bits are all zeros (0x00) or ones (0xff), applying the mask will randomize those sequences.

A more significant problem is geometrical distortion. Although the code is displayed on a planar display (LCD or CRT), the user may capture the code from any arbitrary angle. The code area in the real image could therefore be an arbitrary quadrangle (FIG. 8). To read the data we must know the mapping between matrix entry and the image coordinate. This is a mapping from a rectangle to its perspective image, which can be described by a plane-to-plane homography \tilde{H}:

$$\tilde{H} = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} )$$

For any matrix entry (I,j), \tilde{H} maps homogeneous coordinate x=(I, j, l)^{T} to its image coordinate X:

X=\tilde{H}x (1)

Suppose we know n matrix entries

$$( \begin{matrix}{x}_{1} \\ {y}_{1} \\ 1\end{matrix} ) ( \begin{matrix}{x}_{2} \\ {y}_{2} \\ 1\end{matrix} ) … ( \begin{matrix}{x}_{n} \\ {y}_{n} \\ 1\end{matrix} )$$

and their corresponding image points

$$( \begin{matrix}{X}_{1} \\ {Y}_{1} \\ 1\end{matrix} ) ( \begin{matrix}{X}_{2} \\ {Y}_{2} \\ 1\end{matrix} ) … ( \begin{matrix}{X}_{n} \\ {Y}_{n} \\ 1\end{matrix} )$$

The classical way of computing \tilde{H} is the homogeneous estimation method (see Criminisi, A., Reid, I., And Zisserman, A., “A plane measuring device,” Image and Vision Computing 17, 8, 625-634 (1999)) Reshape matrix \tilde{H} as a vector \tilde{h}=(h11, h12, h13, h21, h22, h23, h31, h32, h33) ^{T} and solve for

$$\begin{matrix}M \tilde{h} = 0 \\ Where & ( 2 ) \\ M = ( \begin{matrix}{x}_{1} & {y}_{1} & 1 & 0 & 0 & 0 & - {x}_{1} {X}_{1} & - {y}_{1} {X}_{1} & - {X}_{1} \\ 0 & 0 & 0 & {x}_{1} & {y}_{1} & 1 & - {x}_{1} {Y}_{1} & - {y}_{1} {Y}_{1} & - {Y}_{1} \\ {x}_{2} & {y}_{2} & 1 & 0 & 0 & 0 & - {x}_{2} {X}_{2} & - {y}_{2} {X}_{2} & - {X}_{2} \\ 0 & 0 & 0 & {x}_{2} & {y}_{2} & 1 & - {x}_{2} {Y}_{2} & - {y}_{2} {Y}_{2} & - {Y}_{2} \\ ⋮ & ⋮ & ⋮ & ⋮ & ⋮ & ⋮ & ⋮ & ⋮ & ⋮ \\ {x}_{n} & {y}_{n} & 1 & 0 & 0 & 0 & - {x}_{n} {X}_{n} & - {y}_{n} {X}_{n} & - {X}_{n} \\ 0 & 0 & 0 & {x}_{n} & {y}_{n} & 1 & - {x}_{n} {Y}_{n} & - {y}_{n} {Y}_{n} & - {Y}_{n}\end{matrix} ) & ( 3 )\end{matrix}$$

When n=4, \tilde{h} is the null-vector of M and we have a unique solution of \tilde{h} for (2) (Assuming |\tilde{h}| or h₃₃=1). This means we only need the coordinates of the four corners (P₁, P₂, P₃, P₄) in FIG. 8 to compute the homography \tilde{H}.

However, solving (2) has some practical difficulties on cell phones. It usually requires LU decomposition with pivoting, which often involves large amount of floating point calculation which is not supported by mobile phones at the hardware level. Instead, The operating systems (Symbian, Windows Mobile) provide software emulation of IEEE-754 64-bit floating point which is much slower than integer operations. Other platforms, such as Java (J2ME), provide no floating point capabilities. This motivates us to search for simpler/faster algorithms without floating point calculation.

We first perform an affine transformation and then perspective transformation. Suppose we know the coordinates of four corners (P₁, P₂, P₃, P₄) in the image plane and the top and bottom boundaries of the bounding box intersect at vanishing point A. Then under homogeneous coordinates

A=L₁×L₂=(P₁×P₄)×(P₂×P₃),

Similarly the left and right boundaries intersect at

B=L₃×L₄=(P₁×P₂)×(P₃×P₄).

A and B are infinite points in the original plane. The third element of A and B under homogenous coordinates should be 0 in the affine image. Any homography

$$H = ( \begin{matrix}\vec{{H}_{1}} \\ \vec{{H}_{2}} \\ \vec{{H}_{3}}\end{matrix} )$$

that maps the perspective image back into affine image should map A and B to infinite, which implies

$$\{ \begin{matrix}{H}_{3} \cdot A = 0 \\ {H}_{3} \cdot B = 0\end{matrix} {H}_{3} \sim A \times B \\ and \\ H 3 \sim ( ( {P}_{1} \times {P}_{4} ) \times ( {P}_{2} \times {P}_{3} ) ) \times ( ( {P}_{1} \times {P}_{2} ) \times ( {P}_{3} \times {P}_{4} ) ) \qquad ( 4 )$$

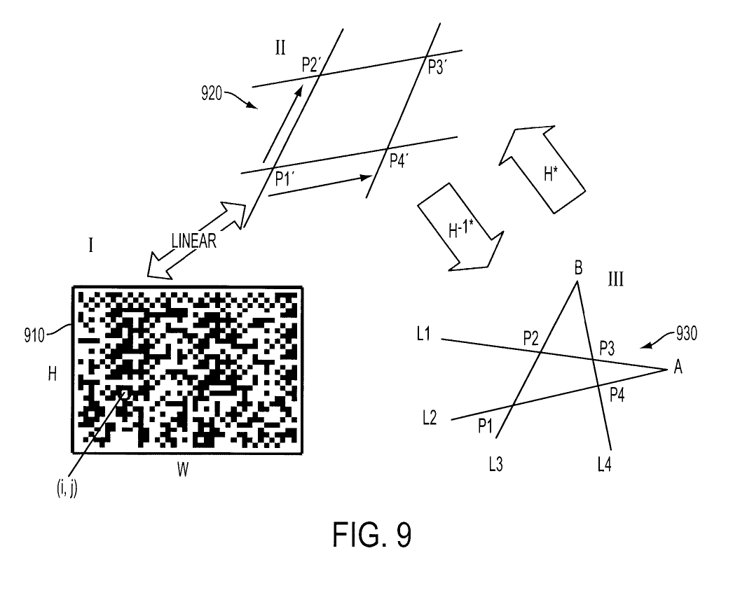

This indicates we can calculate H₃ using seven cross products. As shown in FIG. 9, any homography H with the third row H₃ computed by (4) maps the perspective image 930 to an affine image 920. The next task is to fill in the first and second row of H. The reason to calculate this homography H is that given any matrix coordinate we can quickly tell its pixel coordinate in the image. From the matrix coordinate 910 to the affine image 920, the transformation is linear and can be easily computed by transforming the base of the coordinate system. In last step we need to transform the affine image 920 to the perspective image 930 by computing H⁻¹. We choose the first and second row of H so that it has a neat inverse. With

$$H = ( \begin{matrix}{h}_{33} & 0 & 0 \\ 0 & {h}_{33} & 0 \\ {h}_{31} & {h}_{32} & {h}_{33}\end{matrix} ) \qquad ( 5 )$$

we have (up to scale)

$${H}^{- 1} \sim ( \begin{matrix}{h}_{33} & 0 & 0 \\ 0 & {h}_{33} & 0 \\ - {h}_{31} & - {h}_{32} & {h}_{33}\end{matrix} ) \qquad ( 6 )$$

This “inverse” only requires changing two signs in the third row of H. In this way it simplifies the coordinate transformation with numerical stability. Normally the numerical inverse often suffers from “division by zero” when H is nearly singular.

In summary, instead of linearly solving homography \tilde{H}, we compute the coordinate transformation in the following way:
(1) Compute H₃ using (4);
(2) Compute H and H⁻¹ using (5) and (6);
(3) Map P₁, P₂, P₃, P₄ to affine points P′₁, P′₂, P′₃, P′₄ using H; and
(4) For any entry (i,j) in the w-by-h-matrix compute its affine coordinate

$$\frac{i}{w} \vec{{P}_{1}^{′} {P}_{4}^{′}} + \frac{j}{h} \vec{{P}_{1}^{′} {P}_{4}^{′}}$$

and use H⁻¹ to map this affine coordinate to the image coordinate.
No floating point computation is required in the above procedure.

### Binarization:

For an M×N “VCode” matrix we sample M×N coordinates on the image and read their gray scale values. Then we convert these gray scale values into binary (0 or 1). Since the image may be captured under various lighting conditions, and further affected by changes in perspective angles, a fixed global threshold can not be used. An adaptive thresholding must be used to separate black pixels from white ones. We use k-means (k=2) classification to find the threshold: 1) Find the maximal and minimal values of this M×N gray scale matrix and use them initially as two centers. 2) Assign every pixel to a class whose center is closer to the pixel's gray scale value. 3) Replace the class center by the average value of all the elements in this class. 4) Go back to 2) until the two centers do not change. After the classification, each entry of the M×N matrix is assigned to either 0 or 1.

### Decoding and Data Stream Generation

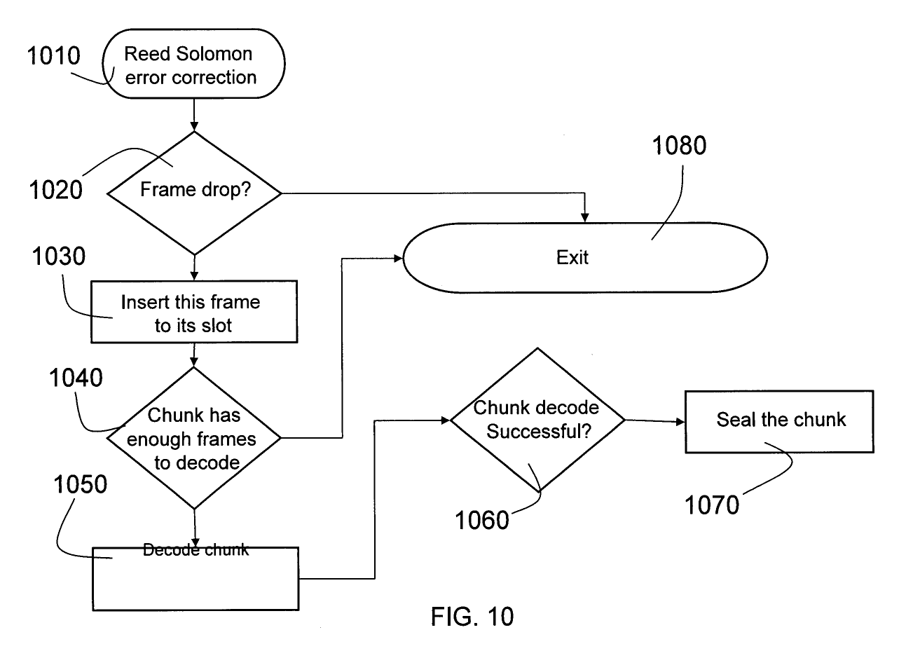

Details of a preferred method of decoding is described with reference to FIG. 10. After a binary matrix is fed to the decoder, the sequence is verified as follows. At step 1010, the frame header is double checked with the checksum. If this frame has been correctly decoded (step 1020), it is decoded and inserted to a slot uniquely assigned to each frame (step 1030). After insertion, the data chunk containing the frame is expanded by one frame. Since we use a (n, k)-Reed-Solomon code to encode the chunk over frames, theoretically we can decode the chunk when the number of accepted frames is larger than k. If the chunk does not have K accepted frames, frames continue to be added (step 1080). If the chunk has k accepted frames (step 1040), decoding starts (step 1050). If decoding succeeds (step 1060), no additional data needs to be added (step 1070). If it fails (step 1060), frames continue to be added (step 1080) until decoding is successful. When all chunks are completed for decoding, the decoder reassembles the stream to generate a file stored to file system on devices.

### V. Implementation

### A. Encoder

Our encoder is implemented as a web service which takes a file as an input and generates a GIF animation (GIF89A). We chose animated GIF because GIF is a standard format which can be opened in web browsers on any platform. Other formats such as MPEG and Flash are also possible but not as popular as an animated GIF. GIF animations can be generated by simply packing frames along the time line, as shown in FIG. 4.

### B. Decoder

Our goal is to support a wide range of devices with various development platforms and operating systems. Porting and maintaining source code of an application among diversified platforms presents a very challenging task. For example, devices running Symbian, Windows Mobile and Palm operating systems have different requirements for development. Developing for the varying architectures, with different conventions for storing of data, different cache architectures, and managing different devices (displays, cameras, network) can be a significant burden for the developer. Efficiently and reliably embedding the same application into these different devices can be very expensive. In our strategy, we begin the development off line with emulators of different devices. The algorithm consists of a set of basic components managed by a core software control module. The core components will manage resources needed by the analysis modules. We then find identical components, and adopt a “one source, multiple project files” strategy. In this way, adding or updating existing algorithms in one platform will automatically update all other platforms. Using this strategy, we have developed for both Symbian OS and Windows Mobile 5 using one copy of source code. Our decoder was tested on Symbian: Nokia 6680 (Series 60 FP2), 7610 (Series 60 FP1) and Windows Mobile: UTStarcom PPC6700 phones. Although these three phones have different intrinsic camera parameters, our decoder works well on all of them without tuning parameters. This shows the stability and compatibility of our algorithm.

The “V-Code” is designed to work in three modes:

(1) The Static Mode: This is similar to existing 2D barcode, a short message is encoded in a static image, and the camera phone reads this message when it scans over the code.
(2) The Handheld Mode: When downloading more data, the camera phone needs to read a sequence of frames and the user will have to hold the phone facing the visual sequence for a period of time. The user does not have to hold very still, as long as the “V-Code” is in scope; the program will track the “V-Code” automatically.
(3) The Dock Mode: Downloading rather long size data. It works when the phone is still and the position of code matrix in the image remains unchanged. In the dock mode, the downloading speed is much faster because no geometrical computation is required after the first frame is located.

An important feature is that, unlike regular key triggered snapshots, the decoder of a preferred embodiment of the present invention is a no touch decoder. Once the decoder is started, the capture is dynamic. It not only eases the usage of software but also provides extra stabilization of the image. Usually a motion blur occurs at the moment the user presses the “capture” key. Since the phone has no hardware “stabilizer” the motion blur caused by key press is critical for image processing. Therefore we use the preview mode and process the frame stream.

For each frame, the first byte indicates its frame type:
Type I—Static Single Frame: the following bytes encode the message body as a null-terminate string.
Type II—Sequence Header: this is a unique frame for sending data file in handheld mode and dock mode. This frame encodes the file name and size.
Type III—Data Frame: this frame encodes a chunk of data beginning with its offset and chunk length. Since each frame carries with its own offset and chunk length, the reading order of the frames has no importance.

When encoding a data file, the encoder generates the sequence header frame according to the file name and size, and then chops the file into chunks and generates data frames for each chunk. In case any of the data frame might be dropped while capturing, all data frames are replicated three times. Finally the encoder puts the sequence header frame together with the data frames into a sequence of frames.

The decoder tries to decode every single frame it “sees” through the camera. To guarantee that the frame is read correctly it will be read twice and only accepted when the two matrices are identical. When reading the matrix, the decoder starts with the first byte, which must be Type I, II or III, to be considered a valid frame.

For Type I, it will decode all other bits in this frame and show it as a popup message. When the decoder sees Type II, which is the sequence header, it allocates the memory according to the file size and gets ready to accept data chunks. For each chunk, a flag is initialized as “incomplete”. When the decoder sees Type III, it first reads its frame offset and if the corresponding chunk is “incomplete” the reader will fill in this chunk and mark it as “complete”. When all chunks are completed the data is dumped to the file system.

An encoder in accordance with a preferred embodiment of the present invention may, for example, be implemented on WIN32 platform and take either a message or a file as input. For a message, it encodes it to a static image (BMP/JPG). For a file, it encodes it to a video file (WMV/AVI) or GIF (GIF89A) animation. The advantage of a GIF animation is that it could be played in any web browser through any platform, while the video file gives the user more control when playing.

A decoder in accordance with a preferred embodiment of the present invention may, for example, be implemented on Nokia Series 60 platform using “ECAM.LIB” which is provided in Symbian OS 7.1 or later. Such a decoder has been tested on Nokia 6680 and 7610 phones.

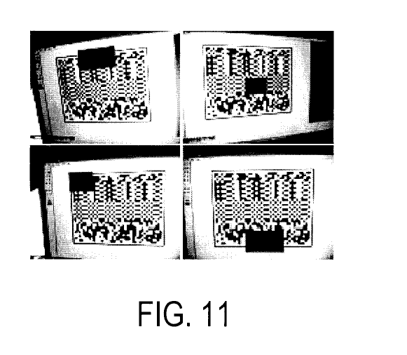

The “V-Code” of the present invention may be used as a data channel, so robustness is an important feature. Practically, the code presented might be noisy or partially occluded causing part of the matrix to be read incorrectly. For these situations we still want to recover the code and that is the reason we choose Reed-Solomon error correction. FIG. 11 shows four manually polluted codes which are still decodable. These examples use (150,100) Reed-Solomon code that encodes 800 bits data with 400 bits error correction codes. They can tolerate approximately 200 bits error that occur anywhere (either on data area or error correction area). Although these images are captured as snapshots, same level of robustness also applies to handheld mode and dock mode.

Another important criteria as a data channel is the speed (bit rate). Unlike the other channels, the “V-Code” of the present invention is visible to the user and the user is actually controlling this channel by hand. The speed must consider HCI (Human Computer Interaction) issues.

Therefore, the following “speed test” is more like a user study than a hardware/protocol test. The “V-Code” of the present inventions was explained to four people, who were then asked to download an image, a ring tong and a small Java program to the Nokia 6680 phone by holding the phone still in front of a laptop screen (Dell Latitude D800, 15″). These three files are all encoded as “V-Code” in the DIVX/MPEG4 video format with a frame rate of 2 frames/second, with 100 bytes of data in each frame. The desired bit rate should be 2×100×8=1600 bps. As a comparison we also download these files in dock mode which has no frame drop. Dock mode performs roughly the same over these three cases because there is no human factor involved. The dock mode frame rate is 1455 bps on average, which is a little lower than 1600 bps because there is overhead on the sequence header and frame header. It is interesting to look at the handheld mode: the bit rate of handheld mode is ⅔ of dock mode (1000/1455), the reason that handheld mode takes longer time is that people cannot hold the phone still all the time. When the hand gets tired and the code drifts out of scope, a frame drop occurs. Since we put three copies of each frame into the sequence of frames, two more chances are provided for each dropped frame to make up later on. However the backup frame might come after tens of frames that have already been consumed. Another observation is that, the longer visual sequence is, the lower bit rate. The reason is that frame drops tend to happen more when people hold the phone for a longer time. After downloading these three files onto the phone, we run a bytewise comparison against the original files and found them identical.

As stated in the performance section, there are two major areas for improvement: speed and usability. In handheld mode, the download speed is 1 KBps and in dock mode it increases to 1.4 KBps, but it is still too slow for real application. As for the completeness of the data, the data sequence is displayed three times. If all three copies of a data frame is dropped, the entire data is unrecoverable incomplete. It is painful if the user holds the phone for two minutes and needs to start over again.

For the speed, in the preview mode a camera phone typically captures 10 VGA (640×480) color (RGB) frames per second. Each frame takes 640×480×3=900K bytes thus 900K×10=9 M bytes information flows into the phone through camera in one second. Compared to our bit rate 1.4 Kbps, we have used only 0.01% of these 9 M bytes. Although we do not expect to achieve mega bit rate through the camera channel, if only we could increase the portion that carry data among these 9 M bytes to 1%, the bandwidth would be 90K bytes per second, which is a lot faster than the current GPRS connection (4 K-5 K bytes per second). To increase the bit rate, one straight forward way is to increase the preview frame rate (fps) but the phone allows at most 10-15 frames per second. An alternative way is to put more content in each frame. Here are some possible solutions:

(1) Increase the grid density. Use smaller size for each black/white pixel in the matrix. This requires the location of the code area to be more accurate. For low density, if the boundary shifts one or two pixels, the data can still be read correctly, but for high density, each data grid might take at most three or four pixel width, there is not much room to tolerate the location error. A more subtle finder pattern should be considered to increase the location accuracy

(2) Use the color information. When reading the image from the camera, each pixels actually takes 24 bits (8 bits each for RGB channels). Although we do not expect to extract 24 bits information from each pixel, a separation on the color channel can increase the bit rate to triple or even more. Note that each camera has a different CMOS/CCD sensor, one color pixel appears differently among all the phones, therefore, to use the color information, a color alignment might be required.

Security can be provided by encrypting the “V-Code” before transmitting or posting the file even when using non-secure methods. For instance, someone leaves an encrypted “V-Code” message on their public webpage for only one or a few people with the password to view the message. Or, a business needs to transmit a message to an employee in the field when the business thinks someone has compromised their security wall.

For the usability, there is a neat solution. We are using error correcting code within each frame, so that under some occlusion the code can still be recovered. We can apply similar error correction across frames. For example, for matrix entry (i,j) even if 20% (depend on the error correction level) of the frames are dropped, the values of (i,j) on all frames are still recoverable. That way, we do not have to repeat the data sequence three times and worry if all three copies are dropped. We only need to insert some error correcting frames between data frames.

Another interesting idea is to print several hundred static “V-Codes” on one page and let the user scan over the page. Suppose we print 20×20=400 code patterns on an A4 page, each encodes 100 bytes, the total amount of information is 40K bytes which can hold a lot J2ME programs. With a close-up lens, the image can be printed even smaller, and more information can fit in one page. There are also issues to explorer about the security, the “V-Code” is hard to break without knowing the mask, the data format and the error correction level, and we can use these as shield to guard the encoded data.

Another method of “Branding” the “V-Code” would be embedding of graphics in the visual stream, either spatially or temporally. Spatially, the graphics can be placed at arbitrary locations within a given frame, subset of frames or the entire sequence. Temporally, the graphics take the place of entire frame for selected frames in the sequence. For instance, the motto of the brand of soda could sporadically appear to flicker throughout the “V-Code” while a user downloaded a coupon. Another instance is when the set of visual frames that download a ring tone to the user also have images showing the singer performing the song being downloaded.

Another idea is to have the “V-Code” have pictures in individual visual frames that when viewed in sequence serve to draw attention to the “V-Code.” For instance, a “V-Code” might show a ball seemingly being kicked around inside the visual frame.

### VI. Examples

One of the direct applications of VCodes is for downloading data through visual communication. From the user's point of view two factors are important: the data transmission speed and robustness. Our experiments evaluate the performance of these two factors.

### A. Data Transmission Speed

The factors directly affecting the data transmission speed are (1) the amount of data encoded in a frame, and (2) the frame rate at which the VCode is displayed and subsequently decoded. Assume the displayed frame rate is P frames/second and D bits are encoded in each frame, then theoretically the overall bit rate is P×D bits per second (bps). Therefore the increase of P and/or D will lead to higher bit rates. Practically however, it is much more complex. For example, if more bits are encoded in a frame (increasing D), it will increase the barcode density and decrease the resolution of a single cell unit when the image is captured, possibly leading to more decoding errors. If the frames are displayed too quickly (increasing P), the device may not be fast enough to capture and process them resulting in missed frames. The experiments we conduct in the following sections result in a quantitative analysis of these factors.

1) Data Capacity in a Single Frame: Currently main stream camera phones can capture a video sequence with resolution of 320×240 pixels. Although a captured still image may have a Mega- or multi-Mega-pixel resolution, a camera phone needs to capture and process frames continuously. Therefore a video mode is required, which limits D. Although the next generation camera phones may capture HDTV quality video, in this paper our analysis is based on the majority of currently available devices.

Like all other 2D barcodes, the resolution (the number of pixels) of a unit cell, defined as a black or white square representing one bit information (either 1 or 0), is crucial for decoding. Given the restriction of the frame size (320×240), increasing the number of bits will decrease the resolution of a unit cell in captured images, leading to higher erroneous bits, and correspondingly, more extra bits being required to correct those erroneous ones. As we addressed above, the total number of bits in a frame (N) consists of the data part (D) and the error correction part (E). The actual data D=N−E. It is important to find a balance between N and E to achieve the optimal result. To investigate this problem we performed a simulation by generating an all-zero data file and encoding it as a VCode with four different settings of unit cells: 28×35, 32×40, 40×50 and 48×60. The reason we select an allzero data file is that zero remains the same after xor operation with the mask defined in FIG. 5 (1 xor 0=1, 0 xor 0=0). After applying the mask, the image looks exactly the same as the mask defined in FIG. 5. When the displayed images are captured and decoded, any 1 in the result indicates an erroneous bit. Another reason that we use an all-zero data file is to eliminate the effect of frame transition (ghost image), which will be discussed in the next section.

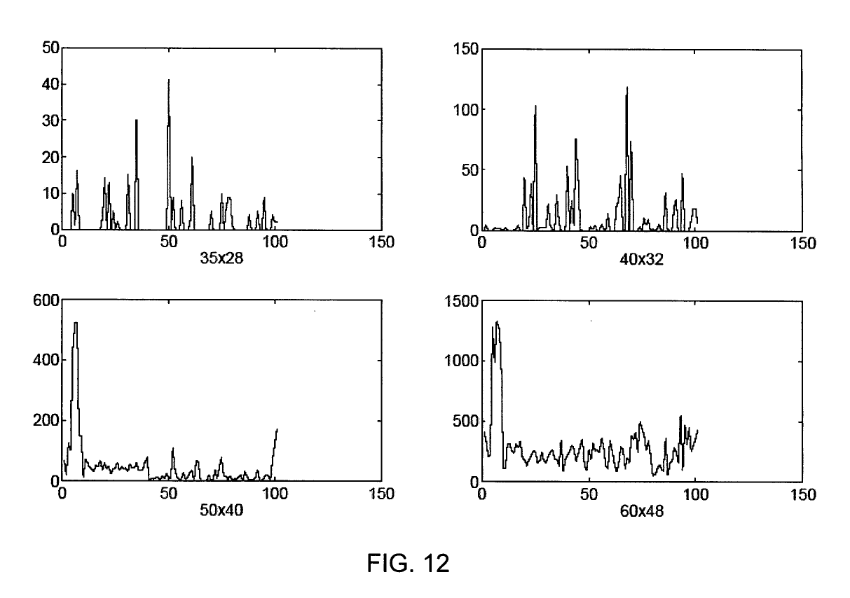

FIG. 12 shows the number of erroneous bits over 100 frames under four different settings. As expected, the larger the value of N, the more erroneous bits are generated and the more error correction bytes E are required to correct them. To predicate the actual performance of these four settings, we define the “Equivalent Bit Rate” EBR as a metric. For F consecutive frames in a VCode, EBR is defined as

$$E B R = \frac{TB}{F \times T} \qquad ( 6 )$$

Where TB is the total number of bits that we can decode from F frames, and T is the time spent on decoding a frame. F=100 in this experiment and T depends on the number of unit cells. Since the complexity of sampling N points from an image and of decoding N-bits data is Θ(N), we have T˜N:

$$E B R \sim \frac{TB}{F \times N} \qquad ( 7 )$$

Let Err(i) be the number of erroneous bits on the iₜₕ frame and Data(i) be the number of bits we read from the iₜₕ frame, which could be either 0 or N−8E, depending on Err(i). If the number of erroneous bits in a frame is too large, the remaining bits will not then be enough to correct them. More specifically, we have:

$$Data ( i ) = \{ \begin{matrix}0 & … Err ( i ) > E / 2 \\ N - 8 E & … Err ( i ) \leq E / 2\end{matrix} \qquad ( 8 )$$

Substituting (8) into (7), we have:

$$E B R \sim \frac{{\sum }_{Err ( i ) \leq E / 2} ( N - 8 E )}{F \times N} \qquad ( 9 )$$

Where iε1 . . . F, as shown in FIG. 12. For a fixed number of unit cells, the only factor that affects EBR is E, the number of error correction bytes. E could neither be too small nor too large. When E is too small, most of the frames with erroneous bytes greater than E/2 will be dropped. When E is too large, however, the error correction code will dominate the frame and little data is encoded. Therefore, the purpose of this experiment is to find an optimal E which maximizes the bit rate.

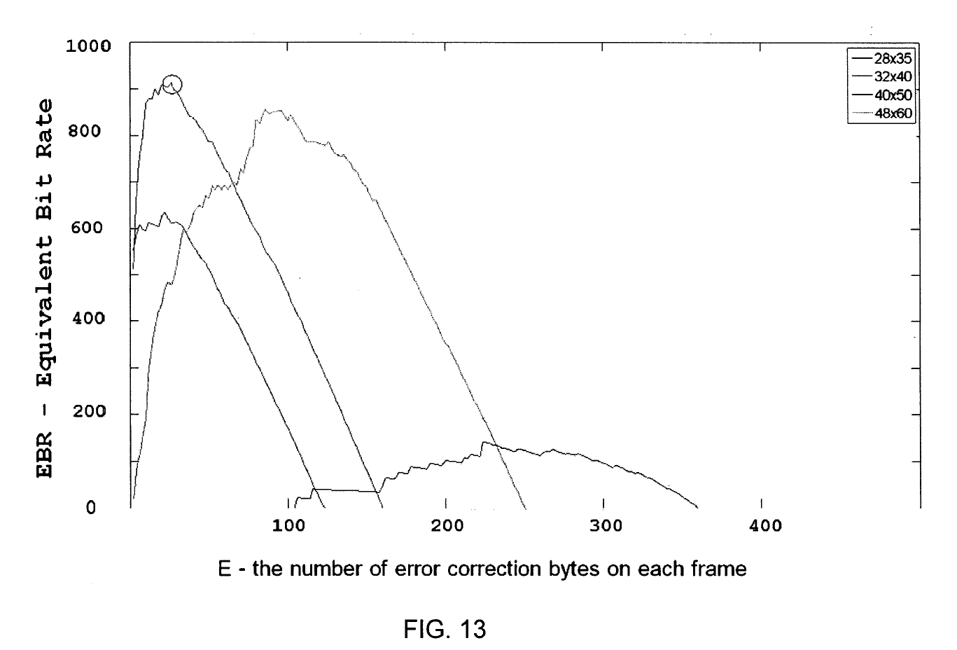

FIG. 13 shows results illustrating relations between EBR and E for four settings (28×35, 32×40, 40×50 and 48×60) respectively. We can see that the largest EBR value is located on the red curve with setting 32×40 and E≈16. The EBR value in the blue curve (setting 28×35) is lower because less information is carried in each frame. On the other hand, the highest N (setting 48×60, corresponding to black curve) actually has very low EBR values due to the large number of erroneous bits. Furthermore, it takes longer to decode a higher resolution frame. Our experiments show that the optimal setting is achieved when the number of unit cells is 32×40 with 16 bytes for error correction.

2) Display Frame Rate: Generally the display frame rate depends on how quickly a frame can be captured and processed by camera phones, and this is device dependent. A frame can not be displayed too quickly since camera phones need to have enough time to perform geometrical correction, decoding and error correction. If it is displayed too slowly, however, the camera phone will have to process the same frame again and again. Although the duplicate data will be identified and removed, re-decoding decreases the overall bit rate. The ideal situation is that camera phones process every frame exactly once. If a frame is dropped, it can be recovered by error correction or be recaptured in the next round since the VCode is displayed in a loop. We tested four different display frame rates with a NOKIA 6680 camera phone as a capture device. The data file selected was a 4 KB MIDI ring tone encoded as a VCode containing 60 frames. The VCode was displayed at frame rate of 20, 10, 6.6, 4 frames/second respectively on a 15 inch flat panel computer monitor. For each frame rate we let three users download the file into the camera phone. The time t used for download is recorded for each run and the throughput is calculated as 4096×8/t bps. The overall results are shown below in Table I.

TABLE I

| Frame Rate | 20 | 10 | 6.6 | 4 |
|---|---|---|---|---|
| User 1 | 360 | 2184 | 2340 | 1365 |
| User 2 | 352 | 2730 | 3276 | 1260 |
| User 3 | 352 | 1928 | 2520 | 1638 |
| Average | 355 | 2280 | 2712 | 1421 |

From Table I, we see that when the animation frame rate is very high (20 fps) or very low (4 fps), the downloading bit rate is low. The optimal result is achieved when the animation frame rate is between 6.6 to 10 fps. To explain these results, we recorded the total number of dropped frames in each run. From Table II, below, we see that when the frame rate is high (20 fps), the number of dropped frames (over 600) is much higher than that of other settings when the final download is finished.

TABLE II

| Frame Rate | 20 | 10 | 6.6 | 4 |
|---|---|---|---|---|
| User 1 | 622 | 63 | 50 | 130 |
| User 2 | 646 | 45 | 30 | 145 |
| User 3 | 675 | 83 | 49 | 100 |
| Average | 648 | 64 | 43 | 125 |

Since VCode contains only 60 frames, a large number of dropped frames indicates the VCode has been displayed in a loop for several times before downloading is complete. There are two reasons for dropping frames: First, the camera phone cannot process a frame within 1/20 sec. Second, when frames are displayed fast, ghost images appear due to the “visual short term memory” of the camera. When black and white cells flip quickly, they appear as a gray color rather than black or white.

When the frame rate is low (5 fps), the frame drop rate is also high because the camera keeps processing duplicate frames. Therefore, a frame rate between 6.6 and 10 is a good choice for the device used in this experiment.

3) Overall Downloading Bit Rate: After analyzing specific factors affecting the download speed we evaluate the overall throughput in a more comprehensive data set. We selected three data files, including a MIDI ring tone, a Java game, and a 3GP video as our test set. The sizes of these files are listed in Table III.

TABLE III
COMPREHENSIVE DOWNLOADING BIT RATE TEST

| Media type | File Size | Hand-held | Dock |
|---|---|---|---|
| Ring tone | 4 KB | 2.67 Kbps | 3.2 Kbps |
| Game | 40 KB | 2.06 Kbps | 2.2 Kbps |
| 3GP Video | 57 KB | 1.18 Kbps | 3.3 Kbps |

We let the same three users download these files and recorded the time spent on downloading when the final download is complete. The bit rate is defined as the quotient of a file size over the time spent on downloading. The average bit rates for downloading are shown in Table III. As we can see, the bit rate decreases as the file size increases. For comparison, we put the phone on a dock on a desk so both of the phone and monitor are static, a configuration we call “dock” mode. In dock mode the download bit rate is very stable, independent of the file size, since no users' factors are involved in and the bit rate is higher (around 3.3 Kbps) than that in handheld mode.

### B. Robustness

1) Aspect Ratios of Displays: Flat panel display devices may have different aspect ratios (such as computer monitors, HDTVs, etc.). For example, on a wide-screen display the displayed image may be stretched to fit the display. This experiment tests the robustness of our algorithm when VCode images are stretched along vertical and horizontal directions. We use a JPEG image file with a size of 4 KB for the experiment. The file was encoded as a VCode and displayed with different aspect ratios ranging from 0.5 to 2.7 (width: height). The downloading speeds are shown in Table IV.

TABLE IV
DOWNLOADING SPEED V. ASPECT RATIO

| | Width/Height | | | | | | | |
|---|---|---|---|---|---|---|---|---|
| | 2.7 | 2.62 | 2.00 | 1.50 | 1.20 | 1.00 | 0.60 | 0.50 |
| Bytes/Second | 0 | 133 | 200 | 400 | 400 | 182 | 47 | 0 |

From Table IV we can see that the best download speed is achieved with aspect ratios from 1.2 to 1.5, i.e. the designed aspect ratio. When a VCode is stretched too wide (with an aspect ratio ≧2.7) or too narrow (with an aspect ratio ≦0.5) the download cannot be completed.

2) Image Contrast: Another factor affecting the performance is the image contrast. During experiments, we found outside lighting contrast does not affect the performance significantly since the displays emit light (like the active lighting) and therefore the display contrast and imaging sensor (camera+CMOS) together affect the contrast of the final image which is the input of V-Code decoder. If the contrast is too low, black and white colors will move closer, the bit error rate will increase significantly. In this section we evaluate the robustness against contrast degradation. Instead of measuring the contrast of the original V-Code frames, we measure the contrast of the actual image being sent to the decoder. Usually the image contrast is defined as the difference of maximal and minimal gray scale values of the image. However, a little bit of random noise can disturb the maximal and minimal gray scale values significantly. Instead, we use the difference between the average gray scale values of white and black pixels to measure the image contrast. These two average gray scale values are computed as a bi-product of the binarization step. For each different level of contrast, we measure the bit rate by averaging the total bytes of data being download over the total number of frames take under that level of contrast. When the distance between white and black average values is larger than 150, the downloading speed is unaffected. When it is smaller than 75, no information can be extracted due to the low display contrast.

These examples demonstrate that cameras can be used for pervasive transfer of data to mobile phones. The encoding and decoding method comprise data splitting, error correction coding, image capture, correction of perspective distortion and decoding. The examples are analyzed quantitatively and provide guidance for the optimal settings which maximize the bit rate. The results show our approach is robust even when the image is stretched or with low display contrast. The present invention provides a new method to enable camera phones to download data when other communication channels do not exist. While the current download speed may be somewhat slower compared with existing wireless or cable connections, this will be significantly improved as camera resolutions become higher and processing speed increases. Further, bit rates may be increased by using color instead of black and white cells in the 2-D bar codes so each cell can carry more bits. If eight colors are used, for example, the speed can be tripled theoretically.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for transferring data to a mobile device, wherein said mobile device comprises a processor, a storage means, and a camera, the method comprising the steps of:
encoding data in a visual code, wherein said visual code comprises a plurality of two-dimensional bar codes;
displaying said visual code, wherein said displaying step comprises displaying a portion of said plurality of two-dimensional bar codes sequentially;
capturing said plurality of two-dimensional bar codes with said camera; and
decoding said plurality of two-dimensional bar codes.

2. A method for transferring data to a mobile device according to claim 1 wherein said encoding step comprises spatial and temporal encoding with Reed-Solomon error correction codes.

3. A method for transferring data to a mobile device, according to claim 1, wherein said encoding step comprises encryption by user-designed masks.

4. A method for transferring data to a mobile device according to claim 1, wherein said displayed plurality of two-dimensional bar codes are square.

5. A method for transferring data to a mobile device according to claim 1, wherein at least two of said displayed plurality of two-dimensional bar codes are different in shape.

6. A method for transferring data to a mobile device according to claim 1, wherein said decoding step comprises boundary tracking with fast Hough transform to locate the code frame in real time.

7. A method for transferring data to a mobile device according to claim 1, further comprising the step of displaying a detected boundary in real time to assist a user in aiming the camera at the visual code.

8. A method for transferring data to a mobile device according to claim 1, wherein said decoding step comprises fast perspective correction.

9. A method for transferring data to a mobile device according to claim 1, wherein colors are embedded in said two-dimensional bar codes.
